(19) United States
(12) Patent Application Publication
(10) Pub. No.: US 2015/0159434 A1
(43) Pub. Date: Jun. 11, 2015

(54) HINGED CONNECTION ELEMENT OF A FOLDING LADDER

(71) Applicant: NEW-TEC INTEGRATION (XIAMEN) CO., LTD., Xiamen (CN)

(72) Inventor: Luhao LENG, Xiamen (CN)

(73) Assignee: NEW-TEC INTEGRATION (XIAMEN) CO., LTD., Xiamen (CN)

(21) Appl. No.: 14/559,125

(22) Filed: Dec. 3, 2014

(30) Foreign Application Priority Data
Dec. 5, 2013 (CN) 201320797188.8

(51) Int. Cl. E06C 1/383; E06C 1/14

(52) U.S. Cl. CPC E06C 1/383; E06C 1/14

(57) ABSTRACT

A ladder includes a rung, two front legs and two rear legs, the front portions at the two sides of the rung are respectively hinged to the two front legs, wherein a hinged connection element comprises a connecting rod and two connection pieces, two connecting pieces are symmetrically attached to the two ends of the connecting rod, each connecting piece comprises a hinged portion, a pivot portion and a fixation portion, the fixation portion is connected to the connecting rod, the hinged portion is hinged to the central portion of the side edge of the rung and to the rear leg, the connecting rod is supported on the bottom of the rung when the rung is unfolded. The connecting piece is hinged to the rung and the rear leg. The fixation portion is fixedly connected to the connecting rod, the connecting rod rotates when the rung is unfolded or folded.

### Filed of the invention

The present invention relates to a hinged connection element of a folding ladder.

### BACKGROUND OF THE INVENTION

In daily use, a stool or a ladder is used to take objects at high place or to disassemble or assemble the electric apparatus at high place. The stool is not stable to stamp, it is dangerous. A ladder unable to fold up has large size, so that it is inconvenient for storage and moving. However, the rung of existing folding ladders is usually directly movably hinged to the front legs and the rear legs, thus making it not flexible to fold up, the rung may be locked during being folded or unfolded.

### SUMMARY OF THE INVENTION

The present invention is provided with a hinged connection element of a folding ladder, which overcomes the disadvantages of the existing technology. The technical proposal of the present invention to solve the technical problems is that:

A hinged connection element of a folding ladder, the ladder comprising a rung, two front legs and two rear legs, the front portions at the two sides of the rung are respectively hinged to the two front legs, wherein the hinged connection element comprises a connecting rod and two connection pieces, two connecting pieces are symmetrically attached to the two ends of the connecting rod, each connecting piece comprises a hinged portion, a pivot portion and a fixation portion, the fixation portion is connected to the connecting rod, the hinged portion is hinged to the central portion of the side edge of the rung, the hinged portion is hinged to the rear leg, the connecting rod is supported on the bottom of the rung when the rung is unfolded.

In another preferred embodiment, the hinged portion and the pivot portion are respectively disposed with hinged hole.

In another preferred embodiment, the fixation portion is fixedly connected to the connecting rod.

In another preferred embodiment, the bottom of the rung is disposed with a lock catch, the lock catch is locked to the connecting rod when the rung is unfolded.

Compared to the existing technology, the technical proposal of the present invention has advantages as below:
1. the connecting piece is hinged to the rung and the rear leg, the distance from the hinged position of the rung and the front leg to the hinged position of the rung and the connecting piece is close, so that it is much flexible when the rung is folded or unfolded, thus preventing the rung from locked.
2. the fixation portion is fixedly connected to the connecting rod, the connecting rod rotates when the rung is being unfolded or folded, the structure is much more stable.
3. the bottom of the rung is disposed with a lock catch, the locked catch is locked to the connecting rod when the ladder is unfolded, so that the ladder is used with safety and reliability.

### BRIEF DESCRIPTION OF THE DRAWINGS

The present invention will be further described with the drawings and embodiments.

FIG. 1 illustrates a schematic diagram of a folding ladder of the present invention.

FIG. 2 illustrates an exploded and schematic diagram of the folding ladder of FIG. 1.

FIG. 3 illustrates a schematic diagram of a hinged connection element.

FIG. 4 illustrates an enlargement diagram of the A part of FIG. 1.

FIG. 5 illustrates a schematic diagram of the folded ladder.

### DETAILED DESCRIPTION OF THE EMBODIMENTS

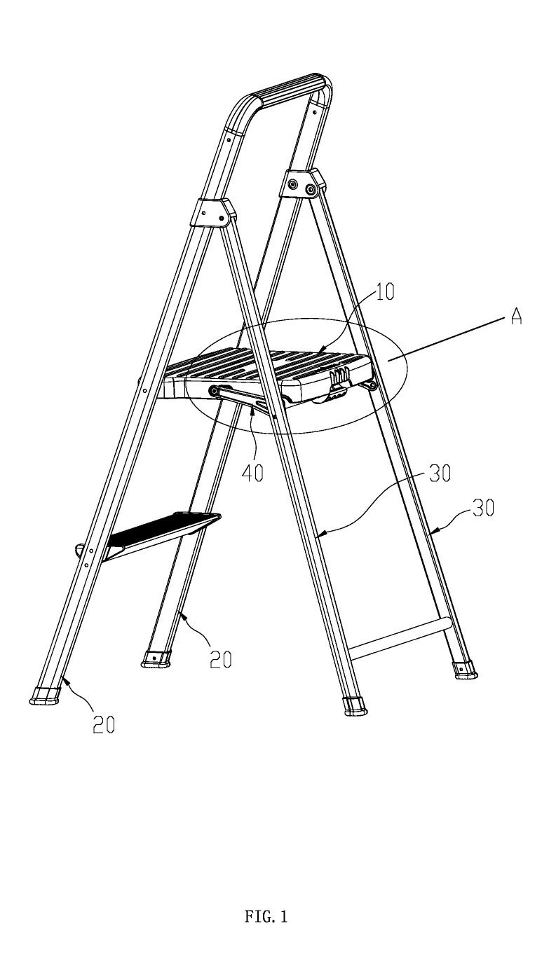

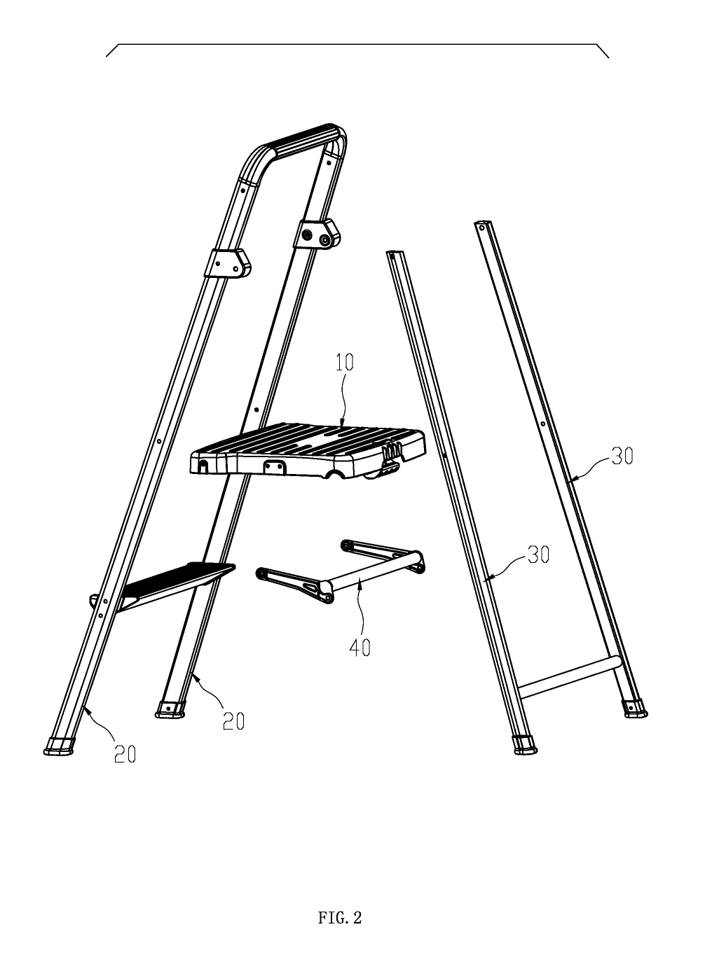

Please refer to FIG. 1 and FIG. 2, a folding ladder comprises a rung 10, two front legs 20, two rear legs 30 and a hinged connection element 40. The rear end of the bottom of the rung 10 is disposed with a lock catch 12. Two front legs 20 are parallel arranged. Two rear legs 30 are parallel arranged as well. Two rear legs 30 are respectively hinged to the two front legs 20. The front legs 20 and the rear legs 30 are applied with existing technology, so they are not described here.

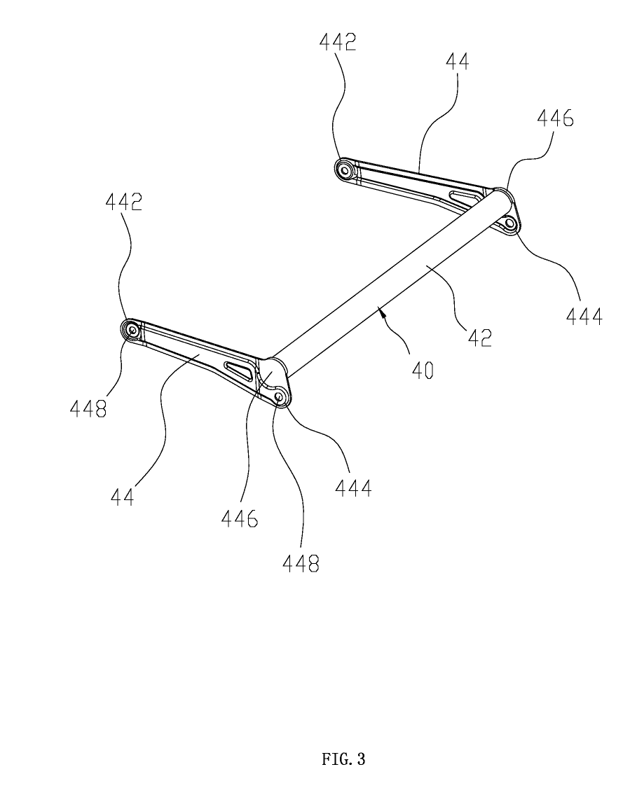

Please refer to FIG. 3, the hinged connection element 40 comprises a connecting rod 42 and two connecting pieces 44. The two connecting pieces 44 are symmetrically connected to the two ends of the connecting rod 42. Each connecting piece 44 comprises a hinged portion 442, a pivot portion 444 and a fixation portion 446. The hinged portion 442 and the pivot portion 444 are respectively disposed at the two ends of the connecting piece 44, the hinged portion 442 and the pivot portion 444 are respectively disposed with a hinged hole 448. The fixation portion 446 is disposed inclined above the pivot portion 444. The fixation portion 446 is fixedly attached to the connecting rod 42 by welding or locking or riveting.

please refer to FIG. 1 to FIG. 3, the front portions of two sides of the rung 10 are respectively hinged to the two front legs 20; the hinged portions 42 of the two connecting piece 44 are respectively hinged to the central portions of the two sides of the rung 10; the pivot portions 444 of the two connecting pieces 44 are respectively hinged to the two rear legs 30.

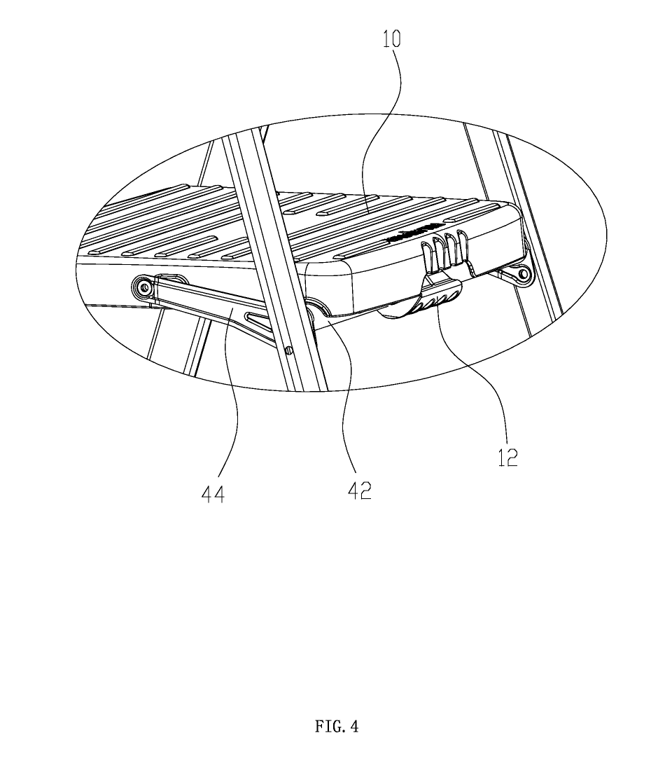

Please refer to FIG. 4, when the rung 10 is unfolded, the connecting rod 42 supports the bottom of the rung 10, so that the ladder has more stable structure, moreover, the lock catch 12 is locked to the connecting rod 42, so that the ladder is used with safety.

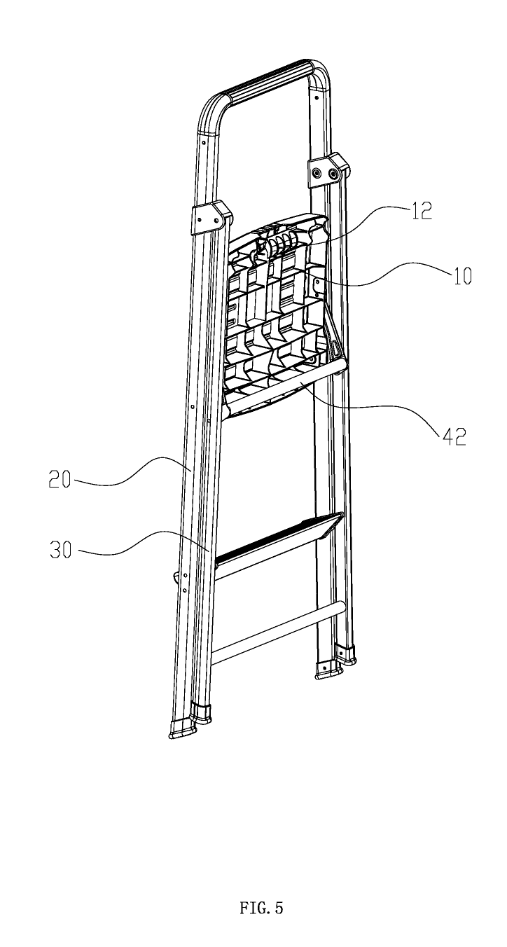

Please refer to FIG. 5, when the rung 10 is folded, as the distance from the hinged portion 442 to the front leg 20 is short, it is labor saving to fold the ladder.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. A hinged connection element of a folding ladder, the ladder comprising a rung, two front legs and two rear legs, the front portions at the two sides of the rung are respectively hinged to the two front legs, wherein the hinged connection element comprises a connecting rod and two connection pieces, two connecting pieces are symmetrically attached to the two ends of the connecting rod, each connecting piece comprises a hinged portion, a pivot portion and a fixation portion, the fixation portion is connected to the connecting rod, the hinged portion is hinged to the central portion of the side edge of the rung, the hinged portion is hinged to the rear leg, the connecting rod is supported on the bottom of the rung when the rung is unfolded.

2. The hinged connection element of a folding ladder according to claim 1, wherein the hinged portion and the pivot portion are respectively disposed with hinged hole.

3. The hinged connection element of a folding ladder according to claim 1, wherein the fixation portion is fixedly connected to the connecting rod.

4. The hinged connection element of a folding ladder according to claim 1, wherein the bottom of the rung is disposed with a lock catch, the lock catch is locked to the connecting rod when the rung is unfolded.
